(19) United States
(12) Patent Application Publication
(10) Pub. No.: US 2006/0105833 A1
(43) Pub. Date: May 18, 2006

(54) Method for assembling a game-selected drawing machine

(76) Inventor: Yueh-Chun Lin, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/989,325

(22) Filed: Nov. 17, 2004

(51) Int. Cl. G06F 17/00; G06F 19/00

(52) U.S. Cl. 463/22

(57) ABSTRACT

A method for assembling a game-selected drawing machine has acts of: providing a drawing machine with a control unit; selecting a game program; providing a ball-set having multiple balls corresponding to the selected game program and loading the balls into the drawing machine, wherein each ball has a symbol; providing a dealing controlling program to deal the balls in accordance with rules of the selected game program; and attaching a display board in front of the drawing machine to display the balls drawn by the drawing machine. By publicly showing the balls in the drawing machine, results of the games can be monitored by players participating in the games. Moreover, the drawing machine can be applied to different games by changing the game programs and the ball-sets.

### BACKGROUND OF THE INVENTION

1. Field of the Invention

The present invention relates to a method for assembling a game-selecting drawing machine, and more particularly to a method that changes the game modes in the drawing machine quickly and conveniently when the drawing machine is assembled.

2. Description of Related Art

Drawing machines have been widely used in lotteries, gambling games, etc and which randomly pick up balls with numbers to decide a winner among many players participating in the game. The conventional drawing machines are mostly used in ‘Bingo’ games, but other conventional gambling games in a casino, such as roulette wheel, Mahjong or cards, are carried out by dealers in manual way. The conventional drawing machine can not be applied to those games. Therefore, each gambling game needs a host (such as a dealer) to control the game so that costs of holding different gambling games in manual are quite high. Moreover, cheating occasionally happens in manual operation by the game host or players when they touch the cards in the gambling game.

Other gambling machines in the casino are completely operated by computer (such as slot machines). However, the computer-operated gambling machine only shows a result of each round on the screen and players can not realize actually how the gambling machine runs. Doubts may be incurred among players because computer programs of the computer-operated gambling machine are not readable and may be modified by the casino owners to reduce the pay out. Therefore, computer-operated gambling machines are not completely trusted by some players.

To overcome the shortcomings, the present invention focuses on a method for assembling a game-selected drawing machine that provides a reliably fair game to mitigate or to obviate the aforementioned problems.

### SUMMARY OF THE INVENTION

The main objective of the present invention is to provide a method for assembling a game-selected drawing machine, which integrates the drawing machine with a selected computer program to provide a reliably fair game. Wherein, the drawing machine shows the chosen balls in public to convince the players that the gambling games are fairly held.

Another objective of the present invention is to provide a method for assembling a game-selected drawing machine that is conveniently changed into different game modes for manufacturing and is automatically operated. Therefore, the selected gambling game needs no real person for a host so that cost of holding the game is greatly reduced.

In order to accomplish the foregoing objectives, the present invention comprises a method for assembling a game-selected drawing machine having the following acts of:

providing a drawing machine with a control unit;

selecting a game program;

providing a ball-set having multiple balls corresponding to the selected game program and loading into the drawing machine, wherein each ball has a symbol and a sensing device;

providing a dealing controlling program to select the balls in accordance with rules of the selected game program;

attaching a display board in front of the drawing machine to display the balls drawn by the drawing machine;

optionally, attaching a name board in front of the drawing machine to shown name of the selected game program; and

optionally, connecting the computer to multiple terminal platforms where the players are located.

With the public display of the chosen balls in the drawing machine, results of the games can be clearly monitored by players participating in the games. Moreover, the drawing machine can be applied to different games by changing the game programs and the ball-sets corresponding to the game programs.

Other objectives, advantages and novel features of the invention will become more apparent from the following detailed description when taken in conjunction with the accompanying drawings.

### BRIEF DESCRIPTION OF THE DRAWINGS

FIG. 1 is a schematically front view of a drawing machine applied in accordance with the present invention;

FIG. 2 is a cross-sectional front view of the drawing machine in FIG. 1;

FIG. 3 shows operational illustrating blocks of a method for assembling a game-selected drawing machine in accordance with the present invention;

FIG. 4-1 shows a cubic ball with “two-tube” symbols;

FIG. 4-2 shows a display board matching “Tube-Mahjong” game;

FIG. 5-1 shows a cubic ball with “Ace” symbols;

FIG. 5-2 shows a display board matching the “Baccarat” game;

FIG. 6-1 shows a round ball with a “75” numeral symbol; and

FIG. 6-2 shows a display board matching the “Bingo” game.

### DETAILED DESCRIPTION OF THE PREFERRED EMBODIMENT

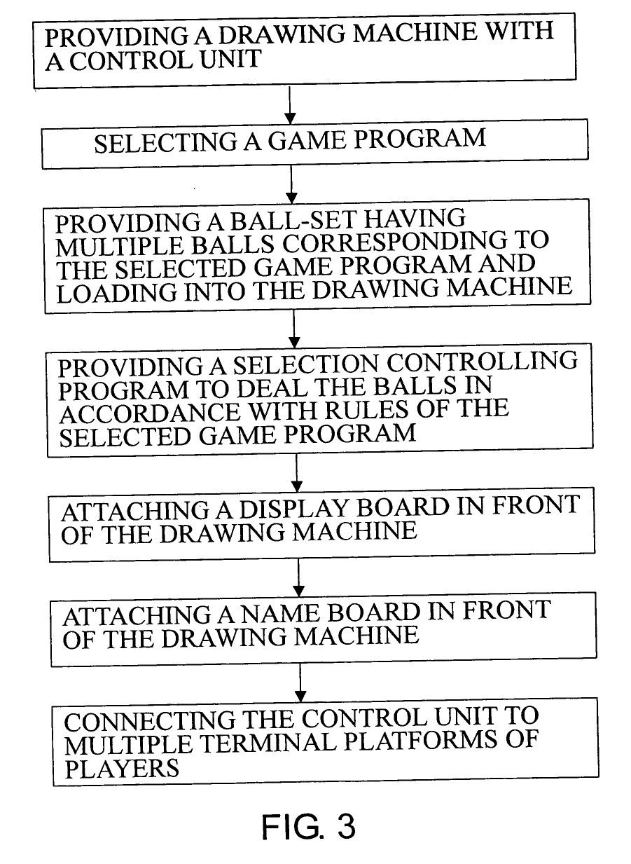

With reference to FIG. 3, a method for assembling a game-selected drawing machine in accordance with the present invention comprises the acts of:

providing a drawing machine with a control unit;

selecting a game program, wherein the game can be stored in the control unit in advance;

providing a ball-set having multiple balls corresponding to the selected game program and loading into the drawing machine, wherein each ball has a symbol;

providing a selection controlling program to select the balls in accordance with rules of the selected game program;

attaching a display board in front of the drawing machine to display the sequence of chosen balls drawn by the drawing machine;

optionally, attaching a name board in front of the drawing machine to show the name of the selected game program; and

optionally, connecting the computer to multiple terminal platforms where players are located.

With the public display of the chosen balls in the drawing machine, results of the games are monitored by players of the games. Moreover, the drawing machine can be applied to different games by changing the game programs and the ball-sets corresponding to the game programs.

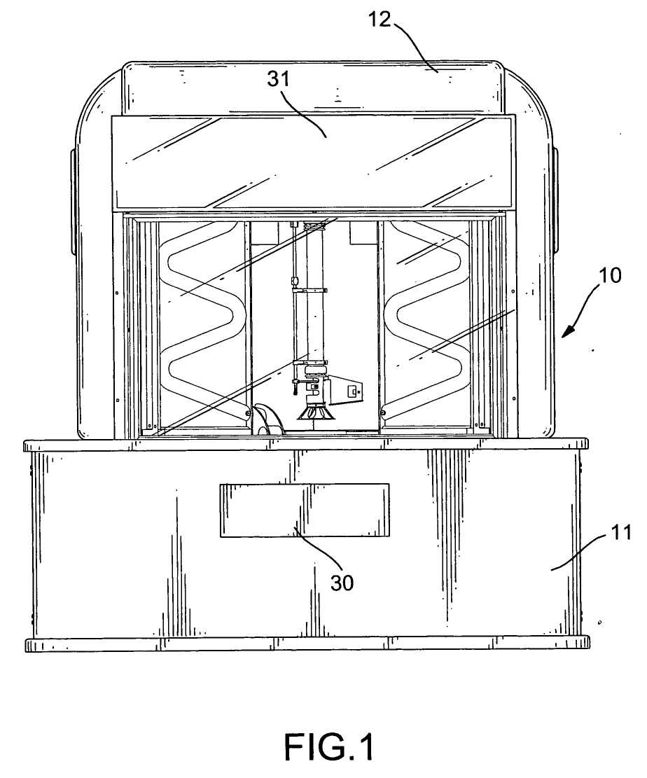

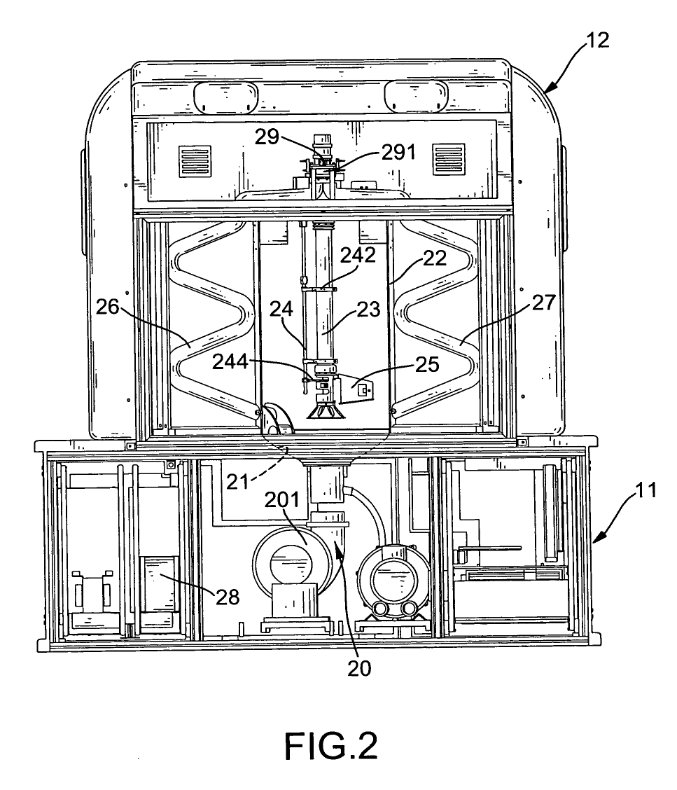

In order to further understand the present invention including the drawing machine and other accessories, detail structures and operations of the drawing machine are illustrated in accordance with FIGS. 1 and 2.

The drawing machine (10) comprises a casing, a ball-activating device (20), a ball selector (23), two curved tubes (26,27), a display board (31), and a name board (30).

The casing is composed of a base (11) and a cover attached to the base. The base (11) has a control unit attached inside the base (11). In a preferred embodiment, the control unit is a computer (28) with multiple controlling programs to automatically control the ball-activating device (20), the display board (31) and other accessories in the drawing machine (10).

The cover (12) is mounted on the base (11) to compose the casing with the base (11). A transparent barrel (22) and is mounted in the casing to contain multiple numbered balls. The barrel (22) has two ball inlets and a funnel bottom (21)

The ball-activating device (20) is mounted in the base (10) and is connected to the bottom of the barrel (12) to activate the balls in the barrel (22) to jump randomly. In a preferred embodiment, the ball-activating device (20) is a blower (201).

The ball selector (23) extends into the barrel (22) to gather individually the numbered balls. In general, the ball selector (23) has a number-detecting device (25) to transmit image of the number on the chosen ball to the display board (31) or to detect the number of the chosen ball. In an operation embodiment, the number-detecting device (25) can be a video camera, chip-detecting device or a barcode reader. The ball selector (23) comprises a tube with an attached end and a distal end and further has a bracket (24) and a stop (244). The attached end of the tube is secured to the top of the barrel (22). The number-detecting device (25) is attached at the distal end of the tube to detect the symbol on the chosen ball entering into the tube. The bracket (24) with a free end longitudinally extends from the top of the barrel (22) and has multiple clamps (242) to hold the tube of the ball selector (23). The stop (244) is formed on the free end of the bracket (24) and extends into the distal end of the tube to retain the ball in front of the number-detecting device (25). Accordingly, the symbol, such as a number on the chosen ball blocked by the stop can be detected by the number-detecting device (25). Preferably, the number-detecting device (25) transmits the images to an individual screen of each player. The structures of the ball-activating device (20) and the ball selector (23) can be same as that of conventional ones and are not further described.

The curved tubes (26,27) are mounted in the casing respectively at two sides of the barrel (22), and each has a top connected to the ball selector (23) and a bottom. The bottoms of the curved tubes (18) are aligned respectively with the ball inlets in the barrel.

Thereby, the ball drawn into the tube of the ball selector (23) slowly slides down along the curved tubes (26, 27) and then stacks with other balls in each round of the game. Every player can witness selection of all balls to ease any doubt about cheating because selection of the balls is in a random variation. The valve is controlled to selectively open and release the balls inside the tubes (26, 27) to enter the barrel (22) again after the round of the game is finished.

A sensor (29) is attached at the attached end on the tube of the ball selector (23) to detect the symbol on the chosen ball, wherein the ball has a sensing device such as an embedded chip or an outer bar-code. Thereby, the sensor (29) can identify the symbol of the chosen ball and then transmit the symbol signal to the control unit (28). The divider (291) is attached under the sensor (29) inside the tube of the ball selector (23) to selectively release the chosen ball into one of the two tubes (26, 27). Preferably, the divider (291) is controlled by one controlling program to divide the chosen balls into two groups respectively in the two tubes (26,27) to catalog into the banker's and the player's balls.

The name board (30) is attached in front of the base (11) to show the name of the game that is set in the drawing machine (10). The display board (31) is attached in front of the cover (12) to show the symbols of the chosen balls within each round of the game. The display board (31) is an electronic board and is controlled by the controlling program in the control unit.

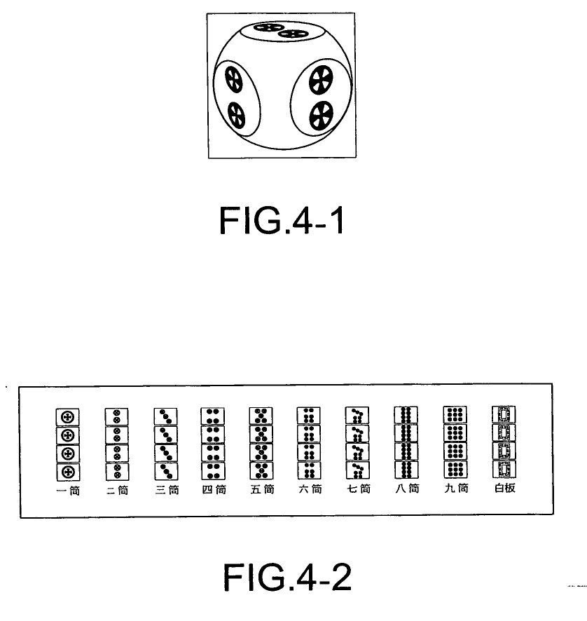

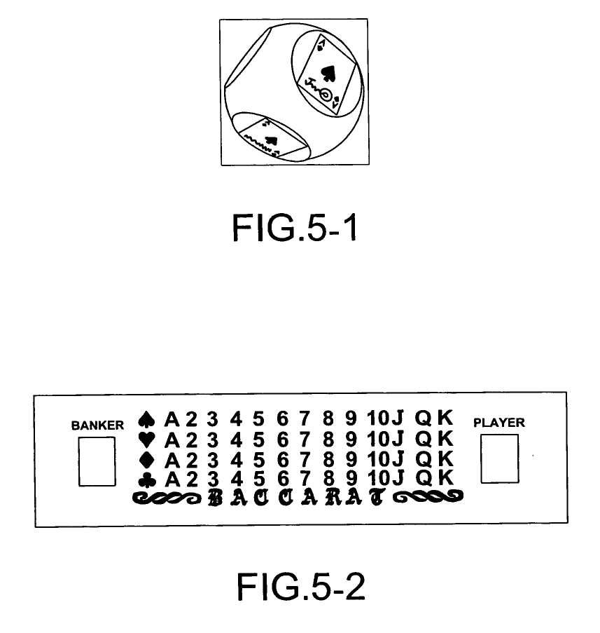

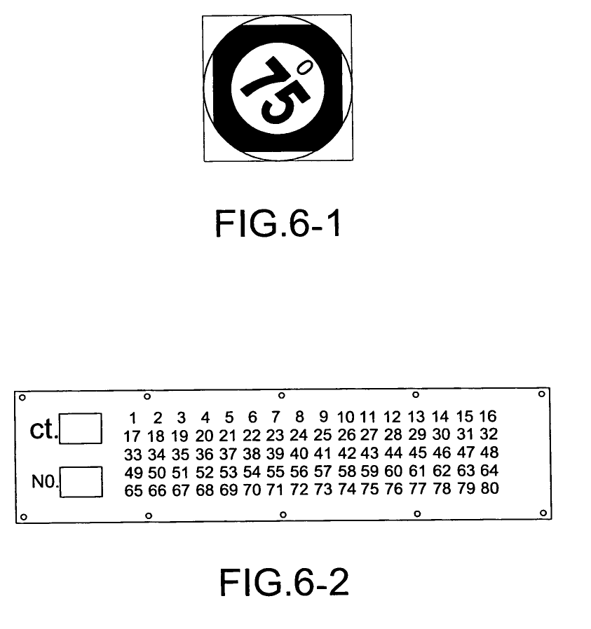

The ball-sets have different variations to correspond to different game programs. For example, when a “Tube-Mahjong” game program is selected, the balls in the ball-set must to have “tube” symbols and each symbol has four balls characterized by the symbol. As shown in FIG. 4, the ball is shaped as a cube and has “two-tube” symbols (4-1). The display board (4-2) shows all symbols and arrangements corresponding to the “Tube-Mahjong” game. FIGS. 5 and 6 show the balls and the display boards respectively to represent “Baccarat” and “Bingo” games.

The operational procedures of the method for assembling the drawing machine are shown in FIG. 3 and are further illustrated in the following.

Providing a drawing machine: a drawing machine as described above is provided and basically has a base (11) with a control unit, a cover (12), a ball-activating device (20), a ball selector (23) and two curved tubes (26,27).

Selecting a game program: the game program is designed based on the rules of a selected game and is inputted into the control unit to operate the drawing machine (10).

Providing a ball-set having multiple balls corresponding to the selected game program: the balls are activated to randomly jump inside the barrel (22) by the ball-activating device (20). The ball-set is designed to correspond to the selected game program and each ball has a symbol.

Providing a dealing controlling program: the dealing controlling program makes the drawing machine (10) automatically deal the balls in accordance with rules of the selected game program.

Attaching a display board (31) and an optional name board (30) in front of the drawing machine (10): the display board (31) is electrically connected with the control unit to show records of the drawn balls and the name board (30) is optionally attached on the drawing machine (10).

Connecting the control unit to multiple terminal platforms where the players are located: after the drawing machine is built and the programs are installed in the control unit, the control unit connects to multiple terminal platforms to allow more players to participate in the game.

After loading the ball-set, the ball-activating device (20) makes the balls jump randomly inside the barrel (22) and then the balls are individually and randomly selected into the ball selector (23) to serve as dealt symbols to the banker or the players. The balls picked by the ball selector (23) are detected by the sensor (29), and the symbol on the selected ball will be shown on the display board (31). Correspondingly, the players can check their staking arrangement until the game is finished.

According to the above description, the method for assembling a game-selected drawing machine has several advantages:

1. By changing the game programs and the ball-sets, the drawing machine (10) is conveniently modified to perform various games to correspond to clients' requests. Therefore, the drawing machine (10) has versatile use and is not limited to only Bingo games.

2. The gambling games are combined with the drawing machine (10) in the present method so that the drawing machine (10) substitutes the personnel hosts as present in the conventional gambling games. The drawing machine (10) can be operated twenty fours hours a day, seven days a week and thus the cost of holding the game is reduced. Moreover, the duration for each round of the game is reduced since the balls do not need shuffling in the way that playing cards do.

3. The balls are drawn by the ball selector (23) at random and are publicly shown to the players when the balls run in the drawing machine (10). Therefore, manual cheating in the gambling game is avoided to erase doubt from the players.

4. The control unit in the drawing machine (10) can be connected to the platforms having multiple player terminals. Therefore, the quantity of the players is not limited in some games such as roulette wheel, whereby more players can participate in a single game.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for assembling a game-selected drawing machine, the method comprising acts of:
providing a drawing machine with a control unit;
selecting a game program;
providing a ball-set having multiple balls corresponding to the selected game program and loading the balls into the drawing machine, wherein each ball has a symbol;
providing a dealing controlling program to deal the balls in accordance with rules of the selected game program; and
attaching a display board in front of the drawing machine to display the balls drawn by the drawing machine.

2. The method as claimed in claim 1, wherein the balls individually have “Mahjong” symbols and the display board is designed to show the “Mahjong” symbols.

3. The method as claimed in claim 1, wherein the balls individually have card symbols and the display board is designed to show the card symbols.

4. The method as claimed in claim 1, wherein the balls individually have numeral symbols and the display board is designed to show the numeral symbols.

5. The method as claimed in claim 1, wherein the method further comprises an act of connecting the control unit to multiple terminal platforms.

6. The method as claimed in claim 5, wherein the method further comprises an act of attaching a name board in front of the drawing machine.
